(19) United States
(12) Patent Application Publication
(10) Pub. No.: US 2020/0409958 A1
(43) Pub. Date: Dec. 31, 2020

(54) BULK ACTION PROCESSING WITH PARTIAL FAILURE RECOVERY

(71) Applicant: Microsoft Technology Licensing, LLC, Redmond, WA (US)

(72) Inventors: Xueqian Tang, Mountain View, CA (US); Chandra Sekhara Srinivas Yenduri, Milpitas, CA (US); Oleg Nikolayevich Anashkin, San Jose, CA (US)

(21) Appl. No.: 16/455,748

(22) Filed: Jun. 28, 2019

(51) Int. Cl. G06F 16/2455; G06F 11/14; G06F 16/25

(52) U.S. Cl. CPC G06F 16/24568; G06F 2201/805; G06F 16/252; G06F 11/1438

(57) ABSTRACT

In an embodiment, the disclosed technologies include determining an identifier; where the identifier identifies an electronic file that contains a set of actions that each include, in a delimiter-separated format, one or more of an argument and a rule that relate to an automated digital content distribution process associated with an online connection network; using a first asynchronous stream processing software, converting the set of actions into a corresponding set of processor-executable events; using an event processing software, generating a real-time stream of state data during the converting; using a second asynchronous stream processing software and a downstream stateful API that is communicatively coupled to the online connection network, independently executing particular events of the corresponding set of processor-executable events; using the event processing software, generating a real-time stream of status data during the executing; mapping the state data and the status data to the identifier to produce bulk result data; reporting the bulk result data to the offline system.

### TECHNICAL FIELD

A technical field related to this disclosure is bulk action processing for online systems.

### BACKGROUND

Online systems often use a network, such as the Internet, to distribute digital content and/or content updates to a large number of users. For example, an online system may use the Internet to allow members to transmit digital content to other users using a ‘share’ or ‘retweet’ function. As another example, an online connection network may use the Internet to transmit digital content, such as connection recommendations, permission updates, news items, advertisements, or job recommendations, to members of the online connection network using autonomous or semi-autonomous processes. Whether initiated by an individual member, a portion of the online system, or another system or service, these distributions of digital content and/or content updates may be directed to a very broad audience of users or they may be targeted to various specific user audiences.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram that depicts an example of a computer-implemented process, in an embodiment;

FIG. 2 is a block diagram that depicts an example software-based system, in an embodiment;

FIG. 3 is another block diagram that depicts an example software-based system, in an embodiment;

FIG. 4 is a block diagram of a networked computing system, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

A technical limitation of existing action processing technologies is that they have been designed and coded to handle only certain types of actions or only specific input file formats. Processing errors occur if an input file or data contained therein deviates from the expected type or format. Another technical limitation of existing approaches is that the action processing has been implemented monolithically using a single processor. Attempts to scale the existing approaches to handle large numbers of actions have experienced frequent failures.

Still another technical limitation of prior action processing approaches is that processing errors and failures are not handled properly. For example, existing tools do not provide a way to restart a process after a partial failure. Yet another technical limitation is that action processing traditionally has been done in a synchronous manner. This approach has proved to be labor intensive for the end user overseeing the action processing. As a result of these and other technical limitations, the former action processing technologies have proven cumbersome, unstable, and unreliable.

Embodiments of the disclosed approach address these and other technical limitations of the former approaches. For example, an embodiment provides a “genericized” conversion process that can be adapted to multiple different action types and input file formats. In an embodiment, input files of different types and formats are converted to a file type and format that can be recognized and processed by the disclosed action processor.

Additionally, some embodiments use asynchronous real-time stream processing technologies to independently process and execute many individual actions concurrently. Further, some embodiments utilize an architecture that decouples action conversion and event execution steps. This allows the disclosed approach to detect errors and partial failures of individual actions during multiple different intermediate stages of the action processing and to retry or restart particular processes while the processing of other actions of the same bulk action continues unaffected.

Benefits that may be realized by at least some embodiments described herein include the ability to accomplish processing of a very large number of actions (collectively, a “bulk action”) via a single file upload, the flexibility to accept multiple different file types and formats, and the ability to respond to failures associated with individual actions of a bulk action without affecting the processing of other actions of the bulk action. An illustrative, nonlimiting example of a very large number of actions is in the range of about 100 or more individual actions. As explained in more detail below, an action as used herein may, when executed by a computer, create or update digital data and/or rules that governs the automated distribution of digital data in an online system.

The disclosed technologies are not limited to the described embodiments, features, and advantages. For example, while some embodiments are disclosed in the context of digital advertising campaigns, aspects of the disclosed technologies also are applicable to other types of bulk actions including but not limited to member permission updates, member connection recommendations, job posting updates, news feed updates, push notifications, and software updates. Additionally, while certain embodiments may be described in the context of an application that uses an online connection network, aspects of the disclosed technologies are equally applicable to other types of online systems. Other embodiments, features and aspects will become apparent from the disclosure as a whole.

Bulk Action Processing

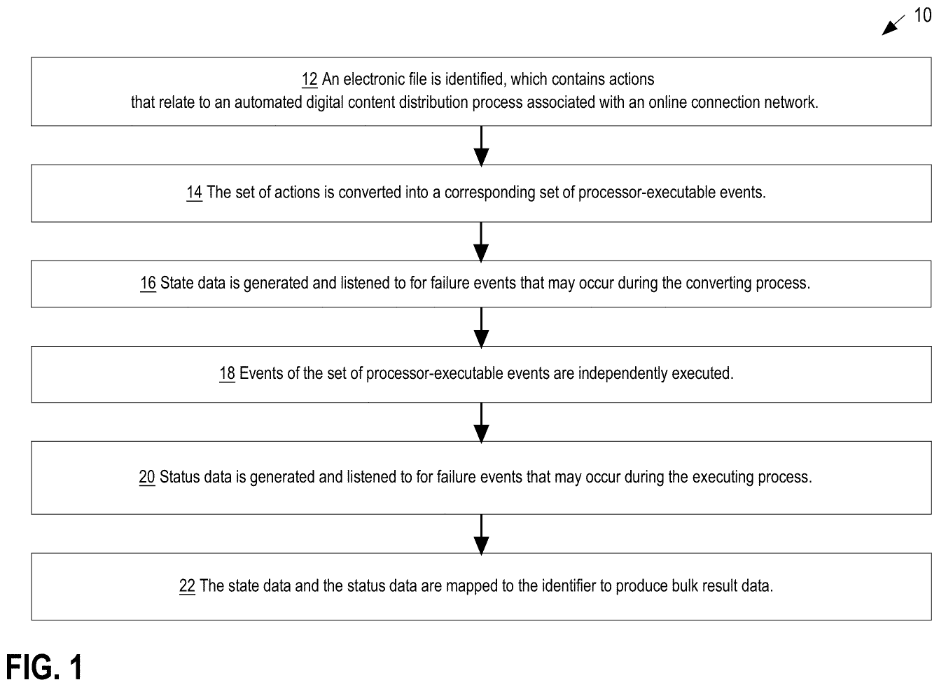

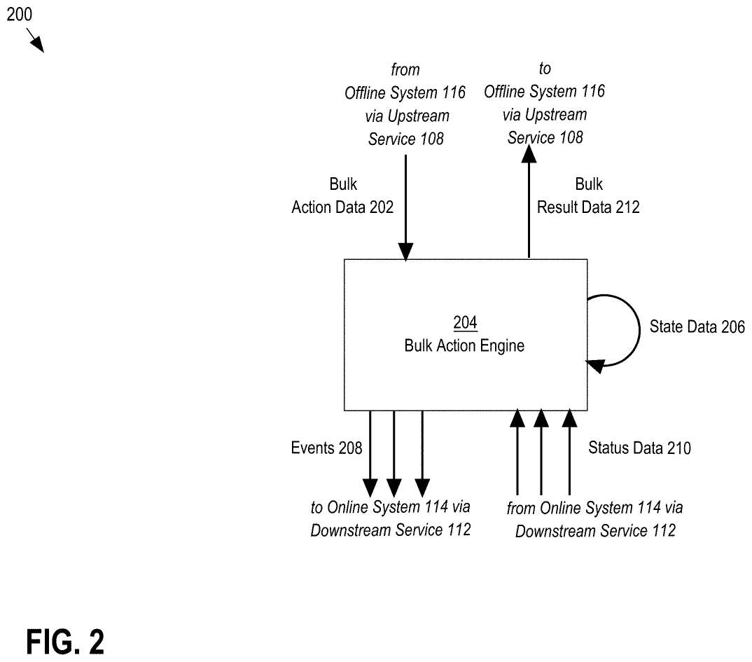

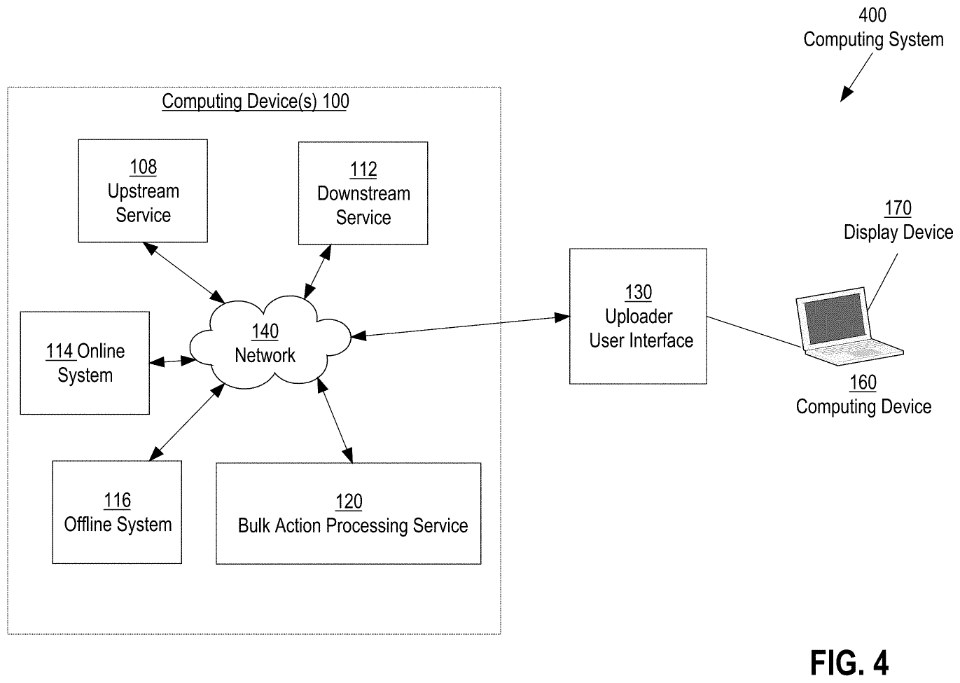

FIG. 1 is a flow diagram that depicts a process 10 that is performed by one or more components of a computing system 300 or computing system 400, embodiments of which are shown in FIGS. 2, 3, and 4, described below, in an embodiment. In some embodiments, portions of process 10 are performed by bulk action engine 204, shown in FIG. 2, described below. In some embodiments, bulk action engine 204 is a component of bulk action processing service 120, shown in FIG. 4, described below. Portions of process 10 may be performed by a single entity or program or by multiple entities or programs, including for example a server computer alone or in combination with a browser plug-in.

The operations of process 10 as shown in FIG. 1 are implemented using processor-executable instructions that are stored in computer memory. For purposes of providing a clear example, the operations of FIG. 1 are described as performed by computing device(s) 100, 160, which may be individually or collectively referred to simply as a ‘computing system.’ In an embodiment, process 10 is configured to facilitate the communication of actions from an offline system 116 via an upstream service 108 to an online system 114 via a downstream service 112, and to facilitate the communication of results data from the online system 114 to the offline system 116 using the upstream service 108 and the downstream service 112.

In operation 12, process 10 identifies an electronic bulk action file. The bulk action file contains a set of actions that each relate to an automated digital content distribution process that can be performed by an online connection network or by an application that uses the online connection network. In an embodiment, an identifier that identifies the bulk action file is determined via an upstream stateful application programming interface (API) that is accessible to an offline system, such as offline system 116. Illustrative, nonlimiting examples of identifiers include a Uniform Resource Name (URN) and a Job ID. Examples of bulk action files that may be identified by operation 12 include but are not limited to a data file containing actions that have been exported by offline system 116, a data file that has been manually created using a template, and a data file that has been created via a user interface, such as uploader user interface 130.

The bulk action file identified in operation 12 contains a set of actions. Action as used herein may refer to a computer-implemented task that relates to an automated digital content distribution process associated with an online connection network or another software application that uses or sits on top of an online connection network. Examples of actions include but are not limited to automated creation or update of large-scale digital advertising campaigns, content distributions, member permission updates, software fixes and upgrades, and other computer-implemented tasks that may be performed on a large number of data entities within an online system.

In an embodiment, each line or row of the electronic file comprises a single action, which includes, in a delimiter-separated format, an argument and/or a rule. In an embodiment, an action may be represented in human-readable text that includes the rule and an argument; for example: “apply coupon when click-through rate exceeds 20%,” where the argument is a threshold value, “20%,” or “add $1000 to account A's budget for campaign X,” where the argument is a threshold value, “$1000.”

In an embodiment, all of the actions in a bulk action file are of the same type and/or relate to the same type of entity. For example, a bulk action file may contain a number of campaign updates each of which updates the click-through rate argument for a different campaign, or a bulk action file may contain a set of actions each of which creates or updates a particular creative that is distributed across the online connection network, or a bulk action file may contain a set of actions each of which updates a particular member account permission across all accounts in a particular member population of the online connection network.

In an embodiment, the file type of the bulk action file is a comma-separated values (CSV) file or an EXCEL file. In an embodiment, the bulk action file identified in operation 12 has been created using a template. An illustrative, non-limiting example of a template is a pre-defined set of column definitions for an advertising campaign, including start time, end time, target audience, and template identifier.

A template may include an example of a line or row of data that defines an action. An end user can save a copy of the template and then simply copy, paste, and tweak a small portion of the template row to create a new action. For example, similar digital advertising campaigns may be created or updated for many different member populations in different geo-locations around the world, such that most of the information is the same across all of the campaigns but the native language may be different for different campaigns. Using a template in this manner can greatly simplify and speed up the process of creating actions for the end user and remove the need for the end user to be concerned with complicated syntax issues during action creation.

In an embodiment, the bulk action file identified in operation 12 is received via a graphical user interface, such as via uploader user interface 130 of FIG. 4, described below. For example, a call to the upstream stateful API may be made via uploader user interface 130.

In operation 14, process 10 converts the set of actions into a corresponding set of processor-executable events. To do this, operation 14 uses a first asynchronous stream processing software, such as a SAMZA processor that has been specifically programmed to read the file type of the bulk action file. The first asynchronous stream processing software processes the individual actions contained in the bulk action file and generates, for example, a KAFKA event for each individual action in the file. In an embodiment, the first asynchronous stream processing software is configured and selected to correspond to the file type of the electronic file identified in operation 12. For example, if the file type is CSV, then the first asynchronous stream processing software is programmed to read lines of a CSV file and generate a KAFKA event for each line of the file. Event as used herein may refer to a processor-executable event that corresponds to a particular action; for example, an event may include a machine-readable instruction and one or more accompanying arguments. For instance, the action, “apply coupon when click-through rate exceeds 20%” may have a corresponding event of “apply_coupon(CTR>20)” and the action “add $1000 to account A's budget for campaign X” may have a corresponding event of “increase_budget(x, 1000).”

In operation 16, process 10 generates state data and listens to the state data to detect failure events that may occur during the converting process. Listening as used herein may refer to a process that periodically executes a query to obtain data and compare the data to a query term such as a threshold value. To do this, operation 16 may use an event processing software, such as KAFKA, to generate a real-time stream of state data during the converting process. State data as used herein may refer to error messages that are output by the conversion process of operation 14. Examples of state data include but are not limited to syntax errors that may be produced by the conversion process during a conversion of an action to an event.

The listening to the state data generated by operation 16 can be performed by another SAMZA processor, for example, such that if a failure is detected in the conversion process for a particular action of the set of actions, the converting process can be retried or restarted for the particular action without affecting the conversion processes for other actions of the bulk action file.

In operation 18, particular events of the set of processor-executable events are independently executed in the online system. To do this, operation 18 uses a second asynchronous stream processing software, such as a SAMZA processor programmed to, in cooperation with a downstream stateful API that is communicatively coupled to the online system, execute the events.

Executing an event causes an entity, such as an automated digital content distribution process or a digital content item or a digital account, for example, to be created or updated in the online system. An entity is assigned an entity identifier or version number upon creation. Thus, the system can determine that actions contained in a bulk action file that do not have an entity identifier or version number are create actions. Similarly, the system can determine that an action contained in the bulk action file that has an entity identifier or a version number is an update action, because the entity already has been created.

In operation 20, status data is generated and listened to for failure events that may occur during the executing process. To do this, operation 20 may use an event processing software, such as KAFKA, to generate a real-time stream of status data. Status data as used herein may refer to messages that are output by event execution processes, such as messages indicating that an event completed successfully or that an event failed to complete successfully.

The status data generated by operation 20 can be listened to by another SAMZA processor, for example, such that if a failure of a particular processor-executable event occurs, the executing of the particular processor-executable event can be restarted without affecting the executing of other events that have been output by operation 18. In an embodiment, the status data includes version information which allows the processor to determine whether or not to restart an event. For instance, if the version number has changed, then that may be an indication that the event completed in which case the system should not re-execute the event. In this case, the system may generate an error message without restarting the event.

In operation 22, the state data and the status data are mapped to the identifier to produce bulk result data. Thereby, the state data and status data for the individual events executed by operation 18 are aggregated for all of the actions contained in the bulk action file identified by operation 12 that have been processed by operations 14 and 18. To do this, the identifier of the bulk action file is passed to the conversion process along with each individual action and passed to the execution process along with each individual event, such that the state data and status data can be aggregated according to the identifier. In an embodiment, the converting process of operation 14 counts the actions of the set of actions as they are converted, to produce a count of actions converted. The count of actions converted is appended to the last action converted so that when the mapping encounters an event that contains the count, it determines that the mapping has completed.

In an embodiment, the bulk result data is output in an electronic file of the same type as the input file type determined in operation 12. For example, if the electronic file identified in operation 12 is a CSV file, operation 22 outputs a CSV file containing the aggregated state data and the aggregated status data. In an embodiment, the bulk result data is reported to the offline system via the upstream stateful API.

Action Engine—Overview

FIG. 2 is a block diagram that depicts an example of a runtime operation of a bulk action processing system, in an embodiment. The software-based components of the system of FIG. 2 include bulk action engine 204. Bulk action engine 204 performs at least the operations of process 10, shown in FIG. 1, described above, in an embodiment.

In operation, bulk action engine 204 receives bulk action data 202 from upstream service 108. Upstream service 108 is for example a REST-type API that is communicatively coupled to offline system 116, as described below with reference to FIG. 4. Bulk action data 202 comprises an electronic data file that contains a number of actions, each of which is represented by data and/or rules listed in a delimiter-separated format. In an embodiment, bulk action data 202 may be a blob that contains the bulk action file.

Bulk action engine 204 processes the bulk action data 202 and outputs corresponding processor-executable events 208 to downstream service 112, such that there is a one to one correspondence between actions read from the bulk action file and events output by bulk action engine 204. Downstream service 112 is for example a REST-type API that is communicatively coupled to online system 114, as described below with reference to FIG. 4. Bulk action engine 204 receives, from online system 114 via downstream service 112, status data 210 that indicates whether execution of particular events succeeded or failed. Bulk action engine 204 also receives state data 206 produced by its own internal conversion processor, which data indicates whether particular conversion processes have encountered errors. Bulk action engine 204 aggregates the status data 210 and the state data 206 to produce and output bulk result data 212. Bulk action engine 204 outputs bulk result data 212 to offline system 116 via upstream service 108.

Action Engine—Detailed Example

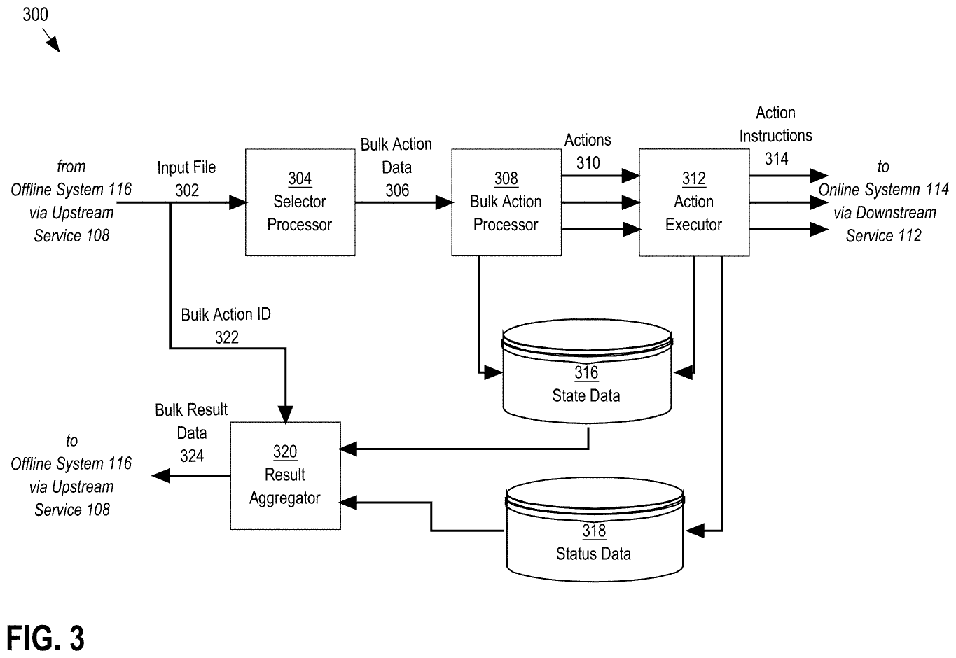

FIG. 3 is a block diagram that depicts another example of a runtime operation of a bulk action processing system 300. The software-based components of the system of FIG. 3 include a selector processor 304, a bulk action processor 308, an action executor 312, a result aggregator 320; and data stores including state data 316 and status data 318. The software-based components of the system of FIG. 3 are part of bulk action engine 204 of FIG. 2, described above, in an embodiment. In an embodiment, bulk action processor 308, action executor 312, and result aggregator 320 each are implemented using an event processing software such as KAFKA (open-source software for building real-time data pipelines, originally developed by LinkedIn Corporation and provided by the Apache Software Foundation) in combination with an asynchronous stream processing software developed using SAMZA (an open-source near-real-time, asynchronous computational framework for stream processing developed by the Apache Software Foundation).

In operation, selector processor 304 receives input file 302 from offline system 116 via upstream service 108. To do this, in an embodiment, upstream service 108 generates or ‘fires’ one or more KAFKA events that specify the identifying information for input file 302 to selector processor 304 and also to result aggregator 320 as bulk action ID 322. It should be understood that references to KAFKA herein include, alternatively, similar functionality of other event processing software that acts as an online/offline connector.

Selector processor 304 is configured to determine the file type of input file 302 and then choose a bulk action processor according to the file type. Selector processor 304 reads, or engages a lightweight service capable of reading the particular file type to read, input file 302. In an embodiment, input file 302 is a blob that contains a CSV file, and selector processor 304 outputs bulk action data 306, which is the contents of the CSV file, to a bulk action processor that is configured to read a CSV file. In other embodiments, selector processor 304 may choose, for example, a bulk action processor that can read an EXCEL file or another file type.

Bulk action processor 308 is triggered to start by a KAFKA event, in an embodiment. Bulk action processor 308 reads bulk action data 306, for example, a CSV file containing a list of actions, and converts the bulk action data 306 into a set of actions 310. In an embodiment, bulk action processor 308 takes whatever form of input is bulk action data 306, converts it to a set of entities using a standardized format that can be executed by action executor 312, and fires another KAFKA event. For example, bulk action processor 308 outputs actions 310 in the form of PEGASUS entities, in an embodiment. In this way, action executor 312 is ‘genericized’ to any type of input file 302. State data includes, for example, indications of whether any errors occurred during the conversion process; for example, syntax errors and/or validation errors. State data generated during operation of bulk action processor 308 is stored in state data 316. State data 316 is a searchable database implemented using, for example, ESPRESSO, a distributed document store available from LinkedIn Corporation. In other embodiments, other suitable data storage technologies are used.

Action executor 312 receives and executes actions 310 in online system 114 through downstream service 112. To do this, action executor 312 listens for KAFKA events fired by bulk action processor 308, in an embodiment. For a given action 310 (i.e., a row or line of bulk action data 306), action executor 312 executes the processor-executable instruction that is represented by the action. Action executor 312 treats each action 310 as an individual, independent job and does not necessarily know how many actions 310 there are in bulk action data 306.

In this way, the architecture of system 300 provides two different SAMZA-type processors that have different scalability: bulk action processor 308 processes only one input file (a single job) and action executor 312 executes many jobs, one for each row of the input file, independently (a high number of small jobs). This approach allows processes started by action executor 312 to restart more quickly after partial failures.

State data generated during operation of action executor 312 is stored in state data 316. Status data generated during operation of action executor 312, for example status data received from online system 114 via downstream service 112, is stored in status data 318.

Result aggregator 320 periodically receives or queries state data 316 and status data 318. To do this, in an embodiment, result aggregator 320 listens to KAFKA data streams resulting from KAFKA events fired by bulk action processor 308 and action executor 312. Result aggregator 320 uses bulk action ID 322 to merge the state data 316 and status data 318 data streams and produce bulk result data 324. Bulk result data 324 represents an aggregate status report for all of the actions contained in input file 302. Result aggregator 320 outputs bulk result data 324 to offline system 116 via upstream service 108. In an embodiment, bulk result data 324, or a link to a file containing bulk result data 324, is displayed via uploader user interface 130.

In this way, the end user managing the action processing merely needs to submit the input file 302 via upstream service 108, for example via uploader user interface 130, and then, at a later time, the results of the bulk action processing are returned via upstream service 108 for review by the end user. Thus, the end user does not need to be concerned with complicated syntax issues or API calls. Additionally, the end user does not need to respond to failures of individual actions piecemeal. Instead, the system automatically attempts to retry partially failed actions while the remaining actions continue processing. Then, after all actions have been processed, the system produces an aggregate report that can be viewed and acted upon by the end user.

### Networked System Example

FIG. 4 is a block diagram of a networked computing system in which bulk action processing service 120 may be implemented. In some embodiments, portions of bulk action processing service 120 may be implemented as part of upstream service 108 or as part of downstream service 112 or as a network-based service; for example, as a nearline or offline service.

Portions of bulk action processing service 120 may communicate with offline system 116 via upstream service 108 and may communicate with online system 114 via downstream service 112, in an embodiment. Upstream service 108 and downstream service 112 are each implemented as one or more web services such as Representational State Transfer (REST) application program interfaces (APIs), in some embodiments.

Computing system 400 includes at least computing device(s) 100, computing device 160, and display device 170, which are communicatively coupled to an electronic communications network 140. Implemented in the devices 100, 160, 170 using computer software, hardware, or software and hardware, are combinations of automated functionality embodied in computer programming code, data structures, and digital data, which are represented schematically in FIG. 1 as upstream service 108, downstream service 112, online system 114, offline system 116, bulk action processing service 120, uploader user interface 130. System as used in this disclosure may refer to a single computer or network of computers and/or other devices. Computing device as used in this disclosure may refer to a computer or any other electronic device that is equipped with a processor.

Although computing system 400 may be implemented with any number N (where N is a positive integer) of upstream service 108, downstream service 112, online system 114, offline system 116, bulk action processing service 120, uploader user interface 130, computing devices 100, display devices 170 and computing devices 160, respectively, in this disclosure, these elements may be referred to in the singular form for ease of discussion.

Also, upstream service 108, downstream service 112, online system 114, offline system 116, bulk action processing service 120, uploader user interface 130 are shown as separate elements in FIG. 1 for ease of discussion but the illustration is not meant to imply that separation of these elements is required. The illustrated systems (or their functionality) may be divided over any number of physical systems, including a single physical computer system, and can communicate with each other in any appropriate manner.

The illustrative upstream service 108, downstream service 112, online system 114, offline system 116, bulk action processing service 120, uploader user interface 130 are communicatively coupled to computing device 160 and to network 140. Portions of upstream service 108, downstream service 112, online system 114, offline system 116, bulk action processing service 120, uploader user interface 130 may be implemented as back-end software applications and/or web-based software applications and/or mobile device applications and may be hosted by a hosting service (not shown). For example, portions of uploader user interface 130 may be implemented within a front-end portion of upstream service 108, or may be embedded within another application or as a separate application. In an embodiment, portions of uploader user interface 130 are implemented in a web browser that can be executed on computing device 160.

In some embodiments, computing device 160 is a client computing device, such as an end user's smart phone, tablet computer, mobile communication device, wearable device, embedded system, smart appliance, desktop computer, or laptop machine, and computing device 100 is a server computer or network of server computers located on the Internet, in the cloud. As illustrated in FIG. 1, display device 170 is implemented in computing device 160 but may be implemented as a separate device or as part of another device, or as multiple networked display devices, in other implementations.

In an embodiment, offline system 116 is a computer system that is external to online system 114 and may be installed on an end user computer; for instance, a computer used by someone who is a member of online system 114. Examples of offline system 116 include but are not limited to digital content creation applications, such as display advertising software, social media advertising software, creative process management software, advertising management software, workflow management software, and standard office tools such as word processing software and spreadsheet software.

In an embodiment, online system 114 is software that is designed to provide a networking service for its members, such as a professional networking service or an online social network service. End users become members of online system 114 through a registration process that includes establishing a user account identifier, password, and online profile. An example of online system 114 is the online professional social network service known as LINKEDIN, provided by LinkedIn Corporation of Sunnyvale, Calif.

Other examples of online system 114 include but are not limited to the “Jobs” component of the LINKEDIN mobile device software application, the “Feed” component of the LINKEDIN mobile device software application, and the web interface of the LINKEDIN TALENT SOLUTIONS product, each provided by LinkedIn Corporation of Sunnyvale, Calif. Still other examples of online system 114 include user-facing portions of other online job listing services, recruiter-oriented online services, online connection networks, and online search engines.

Users of offline system 116 may or may not be registered in online system 114. In some embodiments, registered users of offline system 116 are also registered users of online system 114. In other embodiments, online system 114 and offline system 116 have separate registration processes. In those other embodiments, a portion of online system 114 creates and stores, in an electronic file or a mapping table, for example, a mapping that links the member registration data stored in online system 114 with the member registration data stored offline system 116, to facilitate the exchange of data between the two systems.

Bulk action processing service 120 provides a programmable interface that is at least periodically coupled to uploader user interface 130, upstream service 108 and/or downstream service 112 via network 140, for example on an event-driven basis. Bulk action processing service 120 performs bulk action processing as described in this disclosure.

Computing device 160 communicates with display device 170 and operates uploader user interface 130 to establish logical connection(s) over network 140 with portions of bulk action processing service 120, upstream service 108, and downstream service 112, as the case may be, either directly or via bulk action processing service 120.

In an embodiment, uploader user interface 130 provides a front end application through which non-technical personnel may create and upload bulk action input files to bulk action processing service 120 via upstream service 108. In an embodiment, downstream service 112 is used to communicate processor-executable events output by bulk action processing service 120 to online system 114.

While not specifically shown, a presentation layer may be part of offline system 116 and/or bulk action processing service 120. A presentation layer is server-side software that provides data conversion and data translation services, in an embodiment. A presentation layer facilitates the generation of portions of uploader user interface 130, and includes for example input fields, list boxes, and interactive buttons, for presentation by uploader user interface, in an embodiment.

Network 140 is an electronic communications network and may be implemented on any medium or mechanism that provides for the exchange of data between the devices that are connected to the network. Examples of network 140 include, without limitation, a network such as a Local Area Network (LAN), Wide Area Network (WAN), Ethernet or the Internet, or one or more terrestrial, satellite or wireless links.

### Implementation Example—Hardware Overview

According to one embodiment, the techniques described herein are implemented by one or more computing devices. For example, portions of the disclosed technologies may be at least temporarily implemented on a network including a combination of one or more server computers and/or other computing devices. The computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

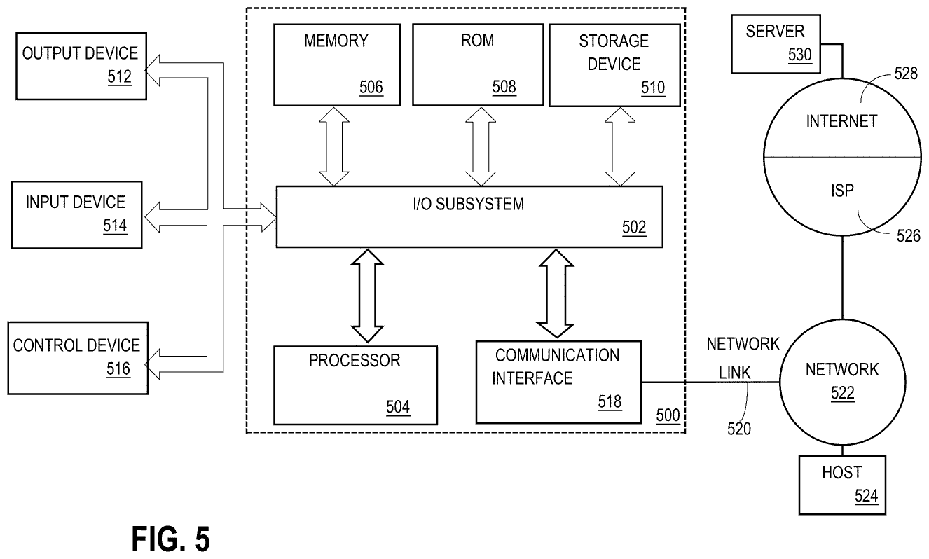

For example, FIG. 5 is a block diagram that illustrates a computer system 500 upon which an embodiment of the present invention may be implemented. Components of the computer system 500, including instructions for implementing the disclosed technologies in hardware, software, or a combination of hardware and software, are represented schematically in the drawings, for example as boxes and circles.

Computer system 500 includes an input/output (I/O) subsystem 502 which may include a bus and/or other communication mechanism(s) for communicating information and/or instructions between the components of the computer system 500 over electronic signal paths. The I/O subsystem may include an I/O controller, a memory controller and one or more I/O ports. The electronic signal paths are represented schematically in the drawings, for example as lines, unidirectional arrows, or bidirectional arrows.

One or more hardware processors 504 are coupled with I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor.

Computer system 500 also includes a memory 506 such as a main memory, which is coupled to I/O subsystem 502 for storing information and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, render computer system 500 into a special-purpose machine that is customized to perform the operations specified in the instructions.

Computer system 500 further includes a non-volatile memory such as read only memory (ROM) 508 or other static storage device coupled to I/O subsystem 502 for storing static information and instructions for processor 504. The ROM 508 may include various forms of programmable ROM (PROM) such as erasable PROM (EPROM) or electrically erasable PROM (EEPROM). A persistent storage device 510 may include various forms of non-volatile RAM (NVRAM), such as flash memory, or solid-state storage, magnetic disk or optical disk, and may be coupled to I/O subsystem 502 for storing information and instructions.

Computer system 500 may be coupled via I/O subsystem 502 to one or more output devices 512 such as a display device. Display 512 may be embodied as, for example, a touch screen display or a light-emitting diode (LED) display or a liquid crystal display (LCD) for displaying information, such as to a computer user. Computer system 500 may include other type(s) of output devices, such as speakers, LED indicators and haptic devices, alternatively or in addition to a display device.

One or more input devices 514 is coupled to I/O subsystem 502 for communicating signals, information and command selections to processor 504. Types of input devices 514 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be implemented as a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

Computer system 500 may implement the techniques described herein using customized hard-wired logic, one or more ASICs or FPGAs, firmware and/or program logic which in combination with the computer system causes or programs computer system 500 to operate as a special-purpose machine. According to one embodiment, the techniques herein are performed by computer system 500 in response to processor 504 executing one or more sequences of one or more instructions contained in memory 506. Such instructions may be read into memory 506 from another storage medium, such as storage device 510. Execution of the sequences of instructions contained in memory 506 causes processor 504 to perform the process steps described herein. In alternative embodiments, hard-wired circuitry may be used in place of or in combination with software instructions.

The term “storage media” as used in this disclosure refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage device 510 either before or after execution by processor 504.

Computer system 500 also includes a communication interface 518 coupled to bus 502. Communication interface 518 provides a two-way data communication coupling to network link(s) 520 that are directly or indirectly connected to one or more communication networks, such as a local network 522 or a public or private cloud on the Internet. For example, communication interface 518 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 518 may include a local area network (LAN) card to provide a data communication connection to a compatible LAN. Wireless links may also be implemented. In any such implementation, communication interface 518 sends and receives electrical, electromagnetic or optical signals over signal paths that carry digital data streams representing various types of information.

Network link 520 typically provides electrical, electromagnetic, or optical data communication directly or through one or more networks to other data devices, using, for example, cellular, Wi-Fi, or BLUETOOTH technology. For example, network link 520 may provide a connection through a local network 522 to a host computer 524 or to other computing devices, such as personal computing devices or Internet of Things (IoT) devices and/or data equipment operated by an Internet Service Provider (ISP) 526. ISP 526 provides data communication services through the world-wide packet data communication network commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### ADDITIONAL EXAMPLES

Illustrative examples of the technologies disclosed herein are provided below. An embodiment of the technologies may include any of the examples or a combination of the described below.

In an example 1, a method includes: determining an identifier; where the identifier identifies an electronic file that contains a set of actions that each include, in a delimiter-separated format, one or more of an argument and a rule that relate to an automated digital content distribution process associated with an online connection network; using a first asynchronous stream processing software, converting the set of actions into a corresponding set of processor-executable events; using an event processing software, generating a real-time stream of state data during the converting; using a second asynchronous stream processing software and a downstream stateful API that is communicatively coupled to the online connection network, independently executing particular events of the corresponding set of processor-executable events; using the event processing software, generating a real-time stream of status data during the executing; mapping the state data and the status data to the identifier to produce bulk result data; reporting the bulk result data to an offline system; where the method is performed by one or more computing devices.

An example 2 includes the subject matter of example 1, including determining a file type of the electronic file; and selecting the first asynchronous stream processing software based on the file type. An example 3 includes the subject matter of example 2, where the file type is a comma-separated values (CSV) file or an EXCEL file. An example 4 includes the subject matter of example 1, including, in response to detecting, using the real-time stream of state data, a failure of the converting of a particular action of the set of actions, restarting the converting for the particular action without affecting the converting of other actions. An example 5 includes the subject matter of example 1, including, in response to detecting, using the real-time stream of status data, a failure of a particular processor-executable event, restarting the executing of the particular processor-executable event without affecting the executing of other events. An example 6 includes the subject matter of example 1, including counting actions of the set of actions during the converting to produce a count of actions converted and using the count of actions converted to determine whether the mapping has completed. An example 7 includes the subject matter of example 1, including determining a file type of the electronic file; and outputting the bulk result data in an electronic file of the file type. An example 8 includes the subject matter of example 1, including receiving the electronic file via a graphical user interface that is communicatively coupled to an upstream stateful API. An example 9 includes the subject matter of example 1, where executing an event of the corresponding set of processor-executable events causes the automated digital content distribution process or a digital content item or a digital account to be created or updated in an online system. An example 10 includes the subject matter of example 1, where the one or more of the argument or the rule relates to a budget threshold or a click-through rate threshold for the automated digital content distribution process. An example 11 includes the subject matter of example 1, where the identifier is determined via an upstream stateful application programming interface (API) that is accessible to an offline system and the bulk result data is reported to the offline system using the using an upstream stateful API.

In an example 12 one or more non-transitory computer-readable storage media storing instructions which, when executed by one or more processors, cause determining an identifier; where the identifier identifies an electronic file that contains a set of actions that each include, in a delimiter-separated format, one or more of an argument and a rule that relate to an automated digital content distribution process associated with an online connection network; using a first asynchronous stream processing software, converting the set of actions into a corresponding set of processor-executable events; using an event processing software, generating a real-time stream of state data during the converting; using a second asynchronous stream processing software and a downstream stateful API that is communicatively coupled to the online connection network, independently executing particular events of the corresponding set of processor-executable events; using the event processing software, generating a real-time stream of status data during the executing; mapping the state data and the status data to the identifier to produce bulk result data; reporting the bulk result data to an offline system.

An example 13 includes the subject matter of example 12, where the instructions, when executed by the one or more processors, further cause determining a file type of the electronic file including a comma-separated values (CSV) file or an EXCEL file; and selecting the first asynchronous stream processing software based on the file type. An example 14 includes the subject matter of example 12, where the instructions, when executed by the one or more processors, further cause, in response to detecting, using the real-time stream of state data, a failure of the converting of a particular action of the set of actions, restarting the converting for the particular action without affecting the converting of other actions. An example 15 includes the subject matter of example 12, where the instructions, when executed by the one or more processors, further cause, in response to detecting, using the real-time stream of status data, a failure of a particular processor-executable event, restarting the executing of the particular processor-executable event without affecting the executing of other events. An example 16 includes the subject matter of example 12, where the instructions, when executed by the one or more processors, further cause counting actions of the set of actions during the converting to produce a count of actions converted and using the count of actions converted to determine whether the mapping has completed. An example 17 includes the subject matter of example 12, where the instructions, when executed by the one or more processors, further cause determining a file type of the electronic file; and outputting the bulk result data in an electronic file of the file type. An example 18 includes the subject matter of example 12, where the instructions, when executed by the one or more processors, further cause receiving the electronic file via a graphical user interface that is communicatively coupled to an upstream stateful API. An example 19 includes the subject matter of example 12, where executing an event of the corresponding set of processor-executable events causes the automated digital content distribution process or a digital content item or a digital account to be created or updated in an online system. An example 20 includes the subject matter of example 12, where the one or more of the argument or the rule relates to a budget threshold or a click-through rate threshold for the automated digital content distribution process.

### GENERAL CONSIDERATIONS

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used in this disclosure the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
determining an identifier;
wherein the identifier identifies an electronic file that contains a set of actions that each comprise, in a delimiter-separated format, one or more of an argument and a rule that relate to an automated digital content distribution process associated with an online connection network;
using a first asynchronous stream processing software, converting the set of actions into a corresponding set of processor-executable events;
using an event processing software, generating a real-time stream of state data during the converting;
using a second asynchronous stream processing software and a downstream stateful API that is communicatively coupled to the online connection network, independently executing particular events of the corresponding set of processor-executable events;
using the event processing software, generating a real-time stream of status data during the executing;
mapping the state data and the status data to the identifier to produce bulk result data;
reporting the bulk result data to an offline system;
wherein the method is performed by one or more computing devices.

2. The method of claim 1, comprising determining a file type of the electronic file; and
selecting the first asynchronous stream processing software based on the file type.

3. The method of claim 2, wherein the file type is a comma-separated values (CSV) file or an EXCEL file.

4. The method of claim 1, comprising, in response to detecting, using the real-time stream of state data, a failure of the converting of a particular action of the set of actions, restarting the converting for the particular action without affecting the converting of other actions.

5. The method of claim 1, comprising, in response to detecting, using the real-time stream of status data, a failure of a particular processor-executable event, restarting the executing of the particular processor-executable event without affecting the executing of other events.

6. The method of claim 1, comprising counting actions of the set of actions during the converting to produce a count of actions converted and using the count of actions converted to determine whether the mapping has completed.

7. The method of claim 1, comprising determining a file type of the electronic file; and outputting the bulk result data in an electronic file of the file type.

8. The method of claim 1, comprising receiving the electronic file via a graphical user interface that is communicatively coupled to an upstream stateful API.

9. The method of claim 1, wherein executing an event of the corresponding set of processor-executable events causes the automated digital content distribution process or a digital content item or a digital account to be created or updated in an online system.

10. The method of claim 1, wherein the one or more of the argument or the rule relates to a budget threshold or a click-through rate threshold for the automated digital content distribution process.

11. The method of claim 1, wherein the identifier is determined via an upstream stateful application programming interface (API) that is accessible to an offline system and the bulk result data is reported to the offline system using the using an upstream stateful API.

12. One or more non-transitory computer-readable storage media storing instructions which, when executed by one or more processors, cause:
determining an identifier;
wherein the identifier identifies an electronic file that contains a set of actions that each comprise, in a delimiter-separated format, one or more of an argument and a rule that relate to an automated digital content distribution process associated with an online connection network;
using a first asynchronous stream processing software, converting the set of actions into a corresponding set of processor-executable events;
using an event processing software, generating a real-time stream of state data during the converting;
using a second asynchronous stream processing software and a downstream stateful API that is communicatively coupled to the online connection network, independently executing particular events of the corresponding set of processor-executable events;
using the event processing software, generating a real-time stream of status data during the executing;
mapping the state data and the status data to the identifier to produce bulk result data;
reporting the bulk result data to an offline system.

13. The one or more non-transitory computer-readable storage media of claim 12, wherein the instructions, when executed by the one or more processors, further cause determining a file type of the electronic file comprising a comma-separated values (CSV) file or an EXCEL file; and selecting the first asynchronous stream processing software based on the file type.

14. The one or more non-transitory computer-readable storage media of claim 12, wherein the instructions, when executed by the one or more processors, further cause, in response to detecting, using the real-time stream of state data, a failure of the converting of a particular action of the set of actions, restarting the converting for the particular action without affecting the converting of other actions.

15. The one or more non-transitory computer-readable storage media of claim 12, wherein the instructions, when executed by the one or more processors, further cause, in response to detecting, using the real-time stream of status data, a failure of a particular processor-executable event, restarting the executing of the particular processor-executable event without affecting the executing of other events.

16. The one or more non-transitory computer-readable storage media of claim 12, wherein the instructions, when executed by the one or more processors, further cause counting actions of the set of actions during the converting to produce a count of actions converted and using the count of actions converted to determine whether the mapping has completed.

17. The one or more non-transitory computer-readable storage media of claim 12, wherein the instructions, when executed by the one or more processors, further cause determining a file type of the electronic file; and outputting the bulk result data in an electronic file of the file type.

18. The one or more non-transitory computer-readable storage media of claim 12, wherein the instructions, when executed by the one or more processors, further cause receiving the electronic file via a graphical user interface that is communicatively coupled to an upstream stateful API.

19. The one or more non-transitory computer-readable storage media of claim 12, wherein executing an event of the corresponding set of processor-executable events causes the automated digital content distribution process or a digital content item or a digital account to be created or updated in an online system.

20. The one or more non-transitory computer-readable storage media of claim 12, wherein the one or more of the argument or the rule relates to a budget threshold or a click-through rate threshold for the automated digital content distribution process.
